(19) United States
(12) Patent Application Publication
(10) Pub. No.: US 2025/0266774 A1
(43) Pub. Date: Aug. 21, 2025

(54) POWER CONVERSION DEVICE

(71) Applicants: Hitachi Astemo, Ltd., Hitachinaka-shi (JP); HONDA MOTOR CO., LTD., Tokyo (JP)

(72) Inventors: Yoshiharu TANABE, Hitachinaka-shi (JP); Kohei NAKANO, Hitachinaka-shi (JP); Takahiro UNEME, Tokyo (JP); Ryuta WAKABAYASHI, Tokyo (JP); Masaki TAKAHASHI, Tokyo (JP); Takahiro KOZEKI, Tokyo (JP)

(21) Appl. No.: 19/051,546

(22) Filed: Feb. 12, 2025

(30) Foreign Application Priority Data
Feb. 16, 2024 (JP) 2024-022437

(51) Int. Cl. H02M 7/00; B60L 50/51; H02M 3/00; H02M 3/158; H02M 7/5387

(52) U.S. Cl. CPC H02M 7/003; B60L 50/51; H02M 3/003; H02M 3/1582; H02M 7/5387

(57) ABSTRACT

A power conversion device includes: a power module forming at least a part of a power conversion circuit; a motor connection AC connector configured to be connected to a motor-side connector included in a motor; a motor connection bus bar connecting the motor connection AC connector and the power module; a cover portion configured to come into contact with the motor-side connector and covering the power module; and a connector-fixing portion formed into a separate body from the cover portion and to which the motor connection AC connector is fixed.

### CROSS REFERENCE TO RELATED APPLICATIONS

The present invention claims priority under 35 U.S.C. § 119 to Japanese Application No. 2024-022437, filed on Feb. 16, 2024, the entire contents of which being incorporated herein by reference.

### BACKGROUND OF THE INVENTION

### Field of the Invention

The present invention relates to a power conversion device.

### Description of Related Art

For example, Japanese Patent No. 6441095 (hereinafter, referred to as Patent Document 1) discloses a connector device that includes an inverter-side connector.

In the connector device disclosed in Patent Document 1, a motor and an inverter are connected to each other by connecting a motor-side connector included in the motor to the inverter-side connector. In the connector device disclosed in Patent Document 1, the inverter-side connector is fixed to an inverter case.

In Patent Document 1, the inverter-side connector is fixed to a cover-shaped inverter case bottom wall portion (hereinafter, referred to as a cover portion) that covers a power module and the like. When the inverter-side connector is inserted into the motor-side connector, the inverter-side connector receives a reaction force from the motor-side connector. Such a reaction force is generated all the time and is received by the cover portion to which the inverter-side connector is fixed. Further, the motor-side connector is pressed against the cover portion. In order to seal the connection between the inverter-side connector and the motor-side connector, the motor-side connector is strongly pressed against the cover portion through a sealing member. Therefore, in the configuration disclosed in Patent Document 1, the force received by the cover portion after manufacturing becomes large, and thus it is difficult to reduce the stiffness of the cover portion.

The present invention has been made in view of the above-described circumstances, and an object of the present invention is to reduce a load on a cover portion and to be able to reduce the stiffness of the cover portion in a power conversion device that includes a motor connection AC connector to which a motor is connected.

### SUMMARY OF THE INVENTION

The present invention adopts the following configuration as means for obtaining the above object.

A power conversion device of an aspect of the present invention includes: a power module forming at least a part of a power conversion circuit; a motor connection AC connector configured to be connected to a motor-side connector included in a motor; a motor connection bus bar connecting the motor connection AC connector and the power module; a cover portion configured to come into contact with the motor-side connector and covering the power module; and a connector-fixing portion formed into a separate body from the cover portion and to which the motor connection AC connector is fixed.

According to the present invention, the motor connection AC connector to which the motor is connected is fixed to the connector-fixing portion formed into a separate body from the cover portion configured to come into contact with the motor-side connector. Therefore, the reaction force acting on the motor connection AC connector by inserting the motor connection AC connector into the motor-side connector is received by the connector-fixing portion. Thus, according to the present invention, it is possible to reduce a load on the cover portion. Consequently, the present invention can reduce the load on the cover portion and reduce the stiffness of the cover portion in the power conversion device that includes the motor connection AC connector to which the motor is connected.

### BRIEF DESCRIPTION OF THE DRAWINGS

FIG. 1 is a schematic configuration diagram of a vehicle on which a power conversion device according to an embodiment of the present invention is mounted.

FIG. 2 is a circuit diagram showing an electrical schematic configuration of a buck-boost converter and an inverter included in the power conversion device according to the embodiment of the present invention.

FIG. 3 is an exploded perspective view showing a structural schematic configuration of the power conversion device according to the embodiment of the present invention.

FIG. 4 is a schematic perspective view of a connector unit included in the power conversion device according to the embodiment of the present invention.

FIG. 5 is a schematic cross-sectional view including the connector unit included in the power conversion device according to the embodiment of the present invention.

### DETAILED DESCRIPTION OF THE INVENTION

In the following, an embodiment of a power conversion device according to the present invention will be described with reference to the drawings.

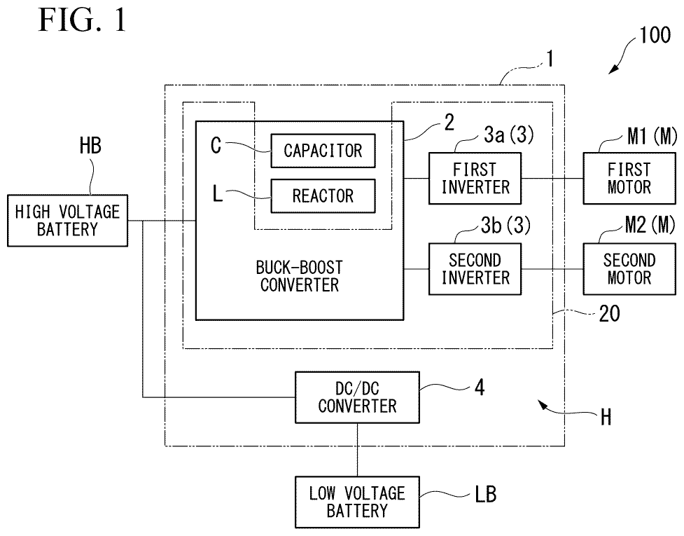

FIG. 1 is a schematic configuration diagram of a vehicle 100 on which a power conversion device 1 of the present embodiment is mounted. The vehicle 100 is, for example, an electric vehicle or a hybrid vehicle. As shown in FIG. 1, the vehicle 100 includes, for example, a high voltage battery HB, a low voltage battery LB, a motor M, and the power conversion device 1 of the present embodiment.

The high voltage battery HB is a secondary battery, such as a lithium ion battery, and outputs relatively high voltage DC power of, for example, about several hundred volts. The high voltage battery HB is a battery that outputs driving electric power to be supplied to the motor M and is a so-called driving battery. The low voltage battery LB is a secondary battery, such as a lead-acid battery, and outputs relatively low voltage DC power of, for example, about 12 V. The low voltage battery LB is a battery that outputs power for auxiliary devices to be supplied to auxiliary devices (not shown) and is a so-called auxiliary device battery.

The motor M generates rotational motive power by the driving electric power being supplied thereto from the high voltage battery HB through the power conversion device 1. The rotational motive power generated by the motor M is transmitted to drive wheels of the vehicle 100 through a transmission mechanism (not shown). In the present embodiment, the motor M includes a first motor M1 and a second motor M2. For example, the first motor M1 generates motive power to be supplied to front wheels of the vehicle 100. In addition, for example, the second motor M2 generates motive power to be supplied to rear wheels of the vehicle 100.

The power conversion device 1 of the present embodiment is a device that performs power conversion. For example, the power conversion device 1 converts DC power into AC power, converts AC power into DC power, or converts voltage. Specifically, the power conversion device 1 of the present embodiment steps up the driving electric power output from the high voltage battery HB, converts it into alternating current, and supplies the alternating current to the motor M. In addition, the power conversion device 1 of the present embodiment converts regenerative power output from the motor M into direct current, steps down it, and supplies it to the high voltage battery HB. Further, the power conversion device 1 of the present embodiment steps down the driving electric power output from the high voltage battery HB to generate power for auxiliary devices and supplies the power for auxiliary devices to the low voltage battery LB.

As shown in FIG. 1, the power conversion device 1 of the present embodiment includes a buck-boost converter 2, an inverter 3, and a DC/DC converter 4. The buck-boost converter 2, the inverter 3, and the DC/DC converter 4 constitute a power conversion circuit H that performs power conversion. The buck-boost converter 2 steps up or steps down the electric power. For example, the buck-boost converter 2 steps up the driving electric power supplied from the high voltage battery HB and outputs it to the inverter 3. In addition, the buck-boost converter 2 steps down the regenerative power supplied from the inverter 3 and outputs it to the high voltage battery HB.

The inverter 3 converts the DC power into the AC power or converts the AC power into the DC power. For example, the inverter 3 converts DC driving electric power supplied from the buck-boost converter 2 into three-phase AC power and outputs the three-phase AC power to the motor M. In addition, the inverter 3 converts AC regenerative power supplied from the motor M into DC power and outputs the DC power to the high voltage battery HB. In the present embodiment, the inverter 3 includes a first inverter 3a and a second inverter 3b. The first inverter 3a is connected to the first motor M1. Further, the second inverter 3b is connected to the second motor M2.

The DC/DC converter 4 steps down the driving electric power output from the high voltage battery HB to convert it into power for auxiliary devices. The DC/DC converter 4 converts DC driving electric power into DC power for auxiliary devices.

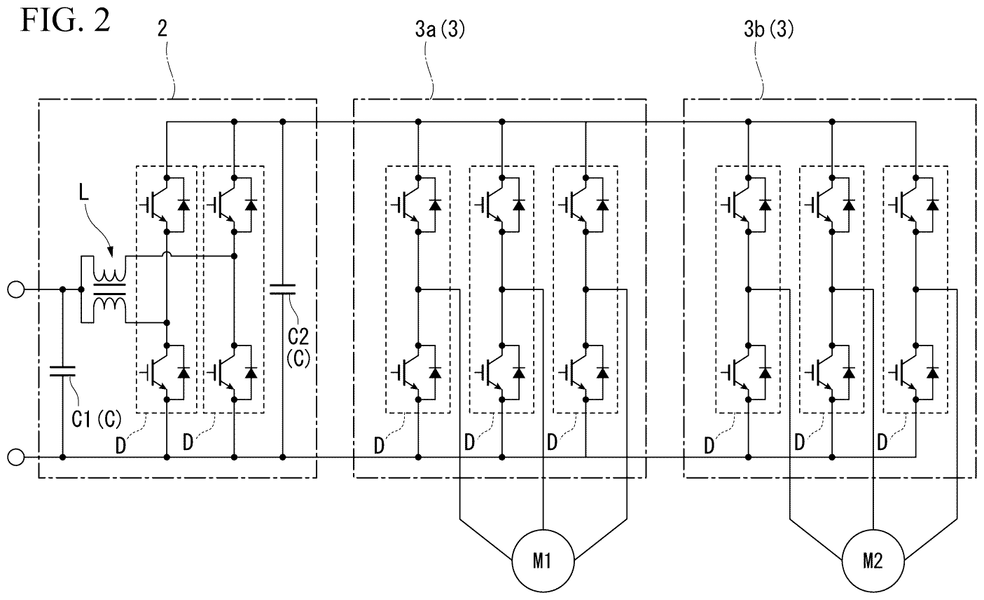

FIG. 2 is a circuit diagram showing an electrical schematic configuration of the buck-boost converter 2 and the inverter 3. As shown in FIG. 2, the power conversion device 1 of the present embodiment includes the buck-boost converter 2 and the inverter 3 that are connected to each other.

The buck-boost converter 2 includes two power devices D, two capacitors C, and a reactor L. One capacitor C (hereinafter, referred to as a first capacitor C1) of the two capacitors C stores electric power before the step-up in a case where electric power is supplied from the high voltage battery HB to the motor M. In addition, the other capacitor C (hereinafter, referred to as a second capacitor C2) of the two capacitors C stores electric power after the step-up in a case where electric power is supplied from the high voltage battery HB to the motor M. Each of the first capacitor C1 and the second capacitor C2 is not limited to being formed of a single element. The first capacitor C1 may be formed of a plurality of elements, or the second capacitor C2 may be formed of a plurality of elements.

In addition, each inverter 3 includes three power devices D. Each power device D has a power transistor. These power transistors have semiconductor elements and are mounted on an insulated circuit board. In the present embodiment, one power device D includes two power transistors. However, a power device having a single power transistor may be provided. In this case, four power devices are provided in the buck-boost converter 2, and six power devices are provided in the inverter 3. For example, each power transistor includes a plurality of semiconductor elements formed of, for example, silicon carbide (SIC). The power transistor may include a semiconductor element formed of other materials such as silicon (Si) or gallium nitride (GaN).

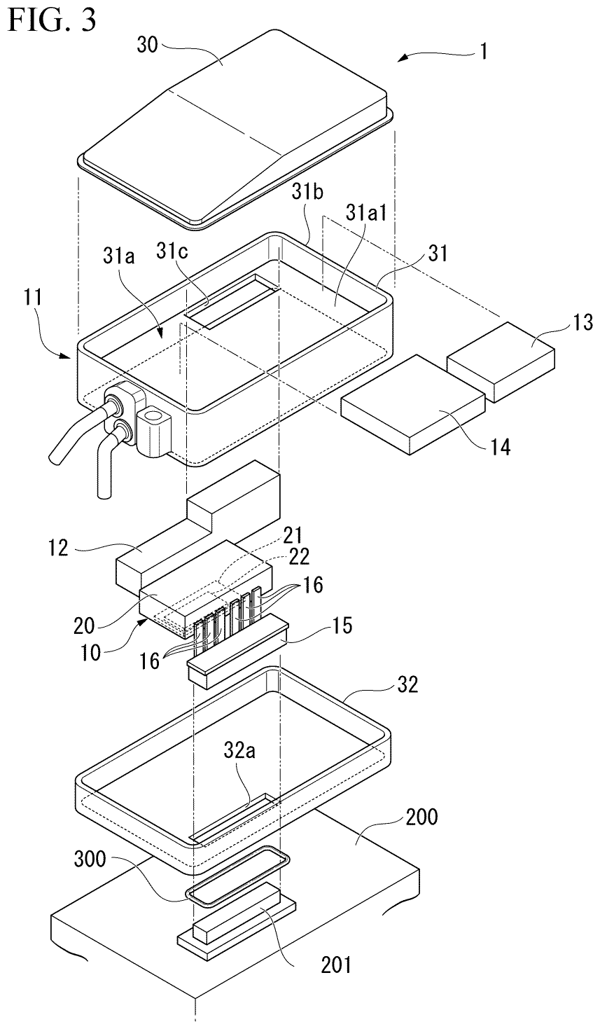

FIG. 3 is an exploded perspective view showing a structural schematic configuration of the power conversion device 1 of the present embodiment. As shown in FIG. 3, the power conversion device 1 of the present embodiment includes an intelligent power module 10, a main body case 11, a capacitor unit 12, a reactor unit 13, a DC/DC converter unit 14, a connector unit 15, and a motor connection bus bar 16.

In the following description, for convenience of description, a side on which the DC/DC converter unit 14 and the like are positioned with respect to a partition wall portion 31a of a central plate 31, which will be described later, of the main body case 11 is referred to as an upper side, and a side on which the intelligent power module 10 is positioned with respect to the partition wall portion 31a of the central plate 31, which will be described later, of the main body case 11 is referred to as a lower side. However, the installation posture of the power conversion device 1 is not particularly limited.

The intelligent power module 10 includes a power module 20, a gate driver board 21, an ECU board 22, and the like. The power module 20 includes a plurality of power devices D having semiconductor elements, a power module case made of a resin that accommodates the plurality of power devices D, and the like.

The gate driver board 21 is a board provided with gate drivers that generate drive signals for the buck-boost converter 2 or the inverter 3, which are formed of the power devices D. Such a gate driver board 21 is stacked on the power module 20. The ECU board 22 is a board provided with an electronic control unit (ECU) that controls the gate driver board 21. The ECU board 22 is stacked on the gate driver board 21. The gate driver board 21 and the ECU board 22 may be integrated together.

The intelligent power module 10 includes the power devices D that constitute the buck-boost converter 2 or the inverter 3. That is, the intelligent power module 10 forms at least a part of the buck-boost converter 2 or the inverter 3.

The main body case 11 is a case that accommodates the intelligent power module 10, the capacitor unit 12, the reactor unit 13, the DC/DC converter unit 14, the connector unit 15, the motor connection bus bar 16, and the like. The main body case 11 includes an upper cover 30, the central plate 31 (support plate, connector-fixing portion), and a lower cover 32 (cover portion). The upper cover 30, the central plate 31, and the lower cover 32 are formed to be separable in the up-down direction.

The upper cover 30 is a portion that covers, from above, the DC/DC converter unit 14 and the reactor unit 13 fixed to the central plate 31 from above. That is, the upper cover 30 is fastened to the central plate 31 through bolts (not shown) or the like.

The central plate 31 is a support plate positioned between the upper cover 30 and the lower cover 32. The central plate 31 includes the flat plate-shaped partition wall portion 31a and a surrounding wall portion 31b provided to surround the partition wall portion 31a from the side of the partition wall portion 31a.

The partition wall portion 31a is disposed such that one surface (hereinafter, referred to as an upper surface 31a1) thereof faces upward and the other surface (hereinafter, referred to as a lower surface 31a2) thereof faces downward. The lower surface 31a2 is shown in FIG. 5. Such a partition wall portion 31a supports, for example, the intelligent power module 10, the capacitor unit 12, the reactor unit 13, and the DC/DC converter unit 14.

In the present embodiment, the reactor unit 13 and the DC/DC converter unit 14 are disposed above the partition wall portion 31a. That is, the reactor unit 13 and the DC/DC converter unit 14 are disposed to face the upper surface 31a1 of the partition wall portion 31a from above. In addition, in the present embodiment, the intelligent power module 10 is disposed below the partition wall portion 31a. That is, the intelligent power module 10 is disposed to face the lower surface 31a2 of the partition wall portion 31a from below. In addition, in the present embodiment, part of the capacitor unit 12 is provided to penetrate the partition wall portion 31a in the up-down direction. Therefore, the partition wall portion 31a is provided with an insertion opening 31c through which the capacitor unit 12 is inserted.

The intelligent power module 10, the capacitor unit 12, the reactor unit 13, the DC/DC converter unit 14, and the connector unit 15 are fastened by bolts (not shown) or the like to bosses or the like provided in the partition wall portion 31a.

Flow paths (not shown) that guide a cooling liquid are provided inside the partition wall portion 31a. By flowing the cooling liquid through the flow paths, the partition wall portion 31a functions as a cooling jacket, and the intelligent power module 10, the capacitor unit 12, the reactor unit 13, the DC/DC converter unit 14, and the connector unit 15 are cooled.

The surrounding wall portion 31b is provided to surround the intelligent power module 10, the capacitor unit 12, the reactor unit 13, and the DC/DC converter unit 14 from the side of them. The surrounding wall portion 31b is connected to the edge portion of the partition wall portion 31a and is provided to protrude upward and downward from the partition wall portion 31a. The upper end of the surrounding wall portion 31b is in contact with the upper cover 30. In addition, the lower end of the surrounding wall portion 31b is in contact with the lower cover 32.

The lower cover 32 is a portion that covers, from below, the intelligent power module 10 fixed to the central plate 31 from below. In addition, the lower cover 32 also covers the capacitor unit 12 and the motor connection bus bar 16 from below. Such a lower cover 32 is fastened to the central plate 31 through bolts (not shown) or the like.

In addition, in the present embodiment, the lower cover 32 comes into contact with a motor-side connector 201 included in a motor unit 200. The motor-side connector 201 comes into contact with the lower cover 32 through a seal member 300. In addition, the lower cover 32 is provided with an opening portion 32a for exposing a motor connection AC connector 15c (refer to FIG. 5), which will be described later, of the connector unit 15. The motor-side connector 201 is inserted into the motor connection AC connector 15c through the opening portion 32a.

The motor unit 200 is a unit including the first motor M1 and the second motor M2. The first motor M1 and the second motor M2 are three-phase AC motors and are driven by electric power supplied from the power conversion device 1 through the motor-side connector 201. Such a motor-side connector 201 is a six-phase connector having terminals for three phases of the first motor M1 and terminals for three phases of the second motor M2.

The capacitor unit 12 is connected to the intelligent power module 10 and is disposed on a side of the power module 20. The capacitor unit 12 is a unit including the capacitors C provided in the buck-boost converter 2. The capacitor unit 12 includes elements that form the capacitors C and a housing that covers the elements.

In the present embodiment, the capacitor unit 12 includes the first capacitor C1 and the second capacitor C2 provided in the buck-boost converter 2. In the capacitor unit 12, the elements forming the first capacitor C1 are disposed inside the capacitor unit 12 to be positioned above the partition wall portion 31a. In addition, the elements forming the second capacitor C2 are disposed inside the capacitor unit 12 to be positioned below the partition wall portion 31a.

The reactor unit 13 is fixed to the central plate 31. The reactor unit 13 is connected to the intelligent power module 10 through a bus bar (not shown) and is disposed above the central plate 31 in the present embodiment. The reactor unit 13 is a unit including the reactor L provided in the buck-boost converter 2.

The DC/DC converter unit 14 is fixed to the central plate 31. The DC/DC converter unit 14 is connected to the intelligent power module 10 through a bus bar (not shown) and is disposed above the central plate 31 in the present embodiment. The DC/DC converter unit 14 is a unit forming the DC/DC converter 4 shown in FIG. 1.

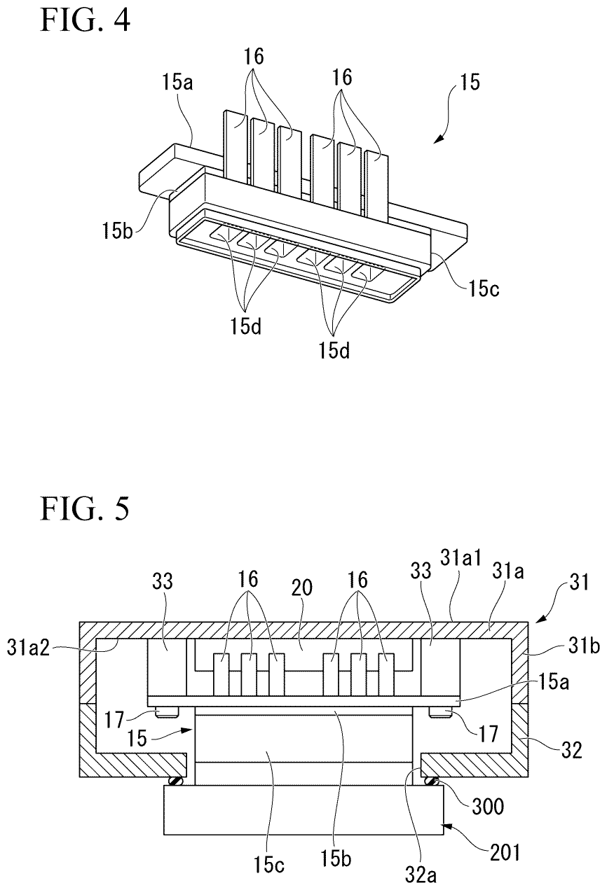

The connector unit 15 is a unit to which the motor-side connector 201 of the motor unit 200 is connected. In the present embodiment, the connector unit 15 is disposed below the partition wall portion 31a of the central plate 31. In addition, the connector unit 15 is disposed further below the intelligent power module 10. FIG. 4 is a schematic perspective view of the connector unit 15. In addition, FIG. 5 is a schematic cross-sectional view including the connector unit 15. As shown in FIGS. 4 and 5, the connector unit 15 includes a metal plate 15a, a resin plate 15b, and the motor connection AC connector 15c.

The metal plate 15a is a plate-shaped strength member that supports the resin plate 15b and the motor connection AC connector 15c. As shown in FIG. 5, the lower surface 31a2 of the partition wall portion 31a of the central plate 31 is a connector-facing surface, which the motor connection AC connector 15c is disposed to face through the metal plate 15a and the resin plate 15b. A plurality of bosses 33 formed to protrude downward from the lower surface 31a2 are provided on the lower surface 31a2 of the partition wall portion 31a. The bosses 33 are portions to which the connector unit 15 (that is, the motor connection AC connector 15c) is fixed. The metal plate 15a is fastened to the distal end of each boss 33 by a bolt 17. The stiffness of the connector unit 15 is improved by such a metal plate 15a.

The plurality of bosses 33 may have different shapes as viewed in the protruding direction thereof (from below). When the shapes of the plurality of bosses 33 are different from each other, for example, an operator can easily visually recognize the bosses 33. In addition, when the shapes of the plurality of bosses 33 are different from each other, for example, it is possible to physically prevent the connector unit 15 from being fastened in a posture different from the correct attachment posture. Therefore, it is possible to suppress incorrect assembly of the connector unit 15.

The resin plate 15b is interposed between the metal plate 15a and the motor connection AC connector 15c. That is, the resin plate 15b is interposed between a surface (in the present embodiment, the lower surface) of the metal plate 15a and the motor connection AC connector 15c. Such a resin plate 15b secures an insulation distance between the metal plate 15a, and the motor connection AC connector 15c and the motor-side connector 201.

The motor connection AC connector 15c is a connector to which the motor-side connector 201 is connected. In the present embodiment, the motor-side connector 201 is a six-phase connector as described above. Therefore, the motor connection AC connector 15c to be connected to the motor-side connector 201 is also a six-phase connector. That is, the motor connection AC connector 15c is a six-phase connector to which the first motor M1 and the second motor M2 are connected. As shown in FIG. 4, the motor connection AC connector 15c includes insertion slots 15d, and each insertion slot 15d corresponds to each phase. These insertion slots 15d are linearly arranged as shown in FIG. 4.

As shown in FIG. 5, the motor connection AC connector 15c is fixed to the boss 33 through the resin plate 15b and the metal plate 15a. Therefore, the motor connection AC connector 15c is fixed to the central plate 31 formed into a separate body from the lower cover 32 that comes into contact with the motor-side connector 201. That is, in the present embodiment, the central plate 31 functions as a connector-fixing portion formed into a separate body from the lower cover 32 and to which the motor connection AC connector 15c is fixed.

In addition, in the present embodiment, as shown in FIG. 5, the power module 20 is supported to face the connector-facing surface (the lower surface 31a2) that is a surface of the partition wall portion 31a included in the central plate 31 on the motor connection AC connector 15c-side. Further, the intelligent power module 10 (that is, the power module 20) is positioned between the connector-facing surface (the lower surface 31a2) and the distal end of the boss 33 in the protruding direction of the boss 33. That is, the intelligent power module 10 is disposed in a space between the connector unit 15, which is fastened to the distal end of the boss 33 from below, and the partition wall portion 31a.

The motor connection bus bar 16 is an electric power transmission member that connects the motor connection AC connector 15c and the power module 20. The motor connection bus bar 16 is provided for each phase of the motor M. That is, in the present embodiment, six motor connection bus bars 16 are provided for a total of six phases, including three phases of the first motor M1 and three phases of the second motor M2. Each motor connection bus bar 16 connects each insertion slot 15d of the motor connection AC connector 15c to an output terminal (not shown) of the power module 20.

The power conversion device 1 of the present embodiment is connected to the motor unit 200 by connecting the motor connection AC connector 15c to the motor-side connector 201 of the motor unit 200. At this time, the motor-side connector 201 is brought into contact with the lower cover 32 through the seal member 300. Therefore, the pressing force added from the motor-side connector 201 is received by the lower cover 32. On the other hand, when the motor connection AC connector 15c is connected to the motor-side connector 201, the motor connection AC connector 15c receives a reaction force from the motor-side connector 201. Here, the motor connection AC connector 15c is fixed to the central plate 31. Therefore, the reaction force described above is received by the central plate 31.

The power conversion device 1 of the present embodiment as described above includes the power module 20, the motor connection AC connector 15c, the motor connection bus bar 16, the lower cover 32, and the connector-fixing portion (the central plate 31). The power module 20 forms at least a part of the power conversion circuit H. The motor connection AC connector 15c is configured to be connected to the motor-side connector 201 included in the motor M. The motor connection bus bar 16 connects the motor connection AC connector 15c and the power module 20. The lower cover 32 is configured to come into contact with the motor-side connector 201 and covers the power module 20. The connector-fixing portion (the central plate 31) is formed into a separate body from the lower cover 32, and the motor connection AC connector 15c is fixed thereto.

According to the power conversion device 1 of the present embodiment, the motor connection AC connector 15c to which the motor M is connected is fixed to the connector-fixing portion (the central plate 31) formed into a separate body from the lower cover 32 that is configured to come into contact with the motor-side connector 201. Therefore, the reaction force acting on the motor connection AC connector 15c by inserting the motor connection AC connector 15c into the motor-side connector 201 is received by the connector-fixing portion (the central plate 31). Therefore, according to the power conversion device 1 of the present embodiment, it is possible to reduce the load on the lower cover 32. Thus, the power conversion device 1 of the present embodiment is a power conversion device including the motor connection AC connector 15c to which the motor M is connected, which can reduce the load on the lower cover 32 and reduce the stiffness of the lower cover 32. Further, the stiffness of the lower cover 32 is reduced, so the power conversion device 1 of the present embodiment is small and lightweight.

In addition, the power conversion device 1 of the present embodiment includes the central plate 31 that supports the power module 20. In addition, the connector-fixing portion is the central plate 31. According to the present embodiment, the central plate 31 having stiffness enough to support the power module 20 can receive the reaction force acting on the motor connection AC connector 15c. Therefore, the reaction force acting on the motor connection AC connector 15c can be stably received. In addition, it is not necessary to provide the connector-fixing portion as a new member by using the central plate 31 as the connector-fixing portion. Accordingly, the power conversion device 1 of the present embodiment can prevent an increase in size and an increase in weight due to the provision of the connector-fixing portion.

In addition, in the power conversion device 1 of the present embodiment, the power module 20 is supported to face the connector-facing surface (the lower surface 31a2) that is a surface of the central plate 31 on the motor connection AC connector 15c-side.

According to the power conversion device 1 of the present embodiment, the power module 20 and the motor connection AC connector 15c can be disposed to be closer to each other than a case where the power module 20 is positioned on the upper surface 31a1-side of the central plate 31. Therefore, according to the power conversion device 1 of the present embodiment, it is possible to shorten the motor connection bus bar 16 and to realize size reduction and weight reduction.

In addition, the central plate 31 of the power conversion device 1 of the present embodiment includes the plurality of bosses 33 formed to protrude from the connector-facing surface (the lower surface 31a2) and to which the motor connection AC connector 15c is fixed. In addition, the power module 20 is positioned between the connector-facing surface (the lower surface 31a2) and the distal end of the boss 33 in the protruding direction of the boss 33.

According to the power conversion device 1 of the present embodiment, the power module 20 is disposed in a space between the connector unit 15 that is fastened to the distal end of the boss 33 from below and the partition wall portion 31a. Therefore, it is possible to effectively use the space between the connector unit 15 and the partition wall portion 31a and to realize size reduction and weight reduction.

In addition, the power conversion device 1 of the present embodiment includes the metal plate 15a and the resin plate 15b. The metal plate 15a is fastened to the distal ends of the plurality of bosses 33. The resin plate 15b is interposed between a surface of the metal plate 15a and the motor connection AC connector 15c. Further, the motor connection AC connector 15c is fixed to the boss 33 through the resin plate 15b and the metal plate 15a.

According to the power conversion device 1 of the present embodiment, the motor connection AC connector 15c can be stably supported by the metal plate 15a, and the motor connection AC connector 15c and the metal plate 15a can be insulated from each other by the resin plate 15b.

In addition, the central plate 31 of the power conversion device 1 of the present embodiment may include the plurality of bosses 33 having different shapes as viewed in the protruding direction. According to the power conversion device 1 of the present embodiment, it is possible to prevent incorrect assembly of the connector unit 15.

In addition, the motor connection AC connector 15c of the power conversion device 1 of the present embodiment is a six-phase connector to which the first motor M1 included in the motor M and the second motor M2 different from the first motor M1 and included in the motor M are connected and includes the insertion slots 15d that are linearly arranged.

In the power conversion device 1 of the present embodiment, the motor connection AC connector 15c can be supported by the connector-fixing portion that is formed into a separate body from the lower cover 32. In a case where the insertion slots 15d are linearly disposed, the motor connection AC connector 15c is thinned. Therefore, the posture of the motor connection AC connector 15c is more likely to be unstable than a case where the insertion slots 15d are disposed in parallel. On the other hand, according to the power conversion device 1 of the present embodiment, the motor connection AC connector 15c can be firmly fixed by supporting the motor connection AC connector 15c by the connector-fixing portion formed into a separate body from the lower cover 32. Therefore, as in the power conversion device 1 of the present embodiment, it is also possible to linearly arrange the insertion slots 15d, and the degree of freedom of the shape of the motor connection AC connector 15c can be improved.

Although the appropriate embodiments of the present invention have been described above with reference to the accompanying drawings, the present invention is not limited to the above embodiments. The shapes, combinations and the like of the constituent members shown in the above-described embodiment are merely examples and can be variously changed based on design requirements and the like within the scope of the present invention.

For example, in the above-described embodiment, the configuration in which the motor connection AC connector 15c is a six-phase connector has been described. However, the present invention is not limited to this. For example, the motor connection AC connector 15c may be a three-phase connector. In such a case, two motor connection AC connectors 15c may be provided. In addition, the motor M may be one.

In addition, in the above-described embodiment, the configuration in which the power module 20 is positioned below the partition wall portion 31a has been described. However, the present invention is not limited to this. For example, it is also possible to adopt a configuration in which the power module 20 is disposed above the partition wall portion 31a.

In addition, in the above-described embodiment, the configuration in which the power device D forming the buck-boost converter 2 is included in the power module 20 has been described. However, the present invention is not limited to this. For example, it is also possible to adopt a configuration in which a buck-boost converter unit forming the buck-boost converter 2 is provided separately from the power module 20.

The above-described embodiments can also be described as, for example, the following appendices.

### Appendix 1

A power conversion device includes: a power module forming at least a part of a power conversion circuit; a motor connection AC connector configured to be connected to a motor-side connector included in a motor; a motor connection bus bar connecting the motor connection AC connector and the power module; a cover portion configured to come into contact with the motor-side connector and covering the power module; and a connector-fixing portion formed into a separate body from the cover portion and to which the motor connection AC connector is fixed.

### Appendix 2

The power conversion device according to Appendix 1, further includes: a support plate supporting the power module, in which the support plate is the connector-fixing portion.

### Appendix 3

The power conversion device according to Appendix 2 is in which the power module is supported to face a connector-facing surface that is a surface of the support plate on the motor connection AC connector-side.

### Appendix 4

The power conversion device according to Appendix 3 is in which the support plate includes a plurality of bosses formed to protrude from the connector-facing surface and to which the motor connection AC connector is fixed, and the power module is positioned between the connector-facing surface and a distal end of a boss of the plurality of bosses in a protruding direction of the boss.

### Appendix 5

The power conversion device according to Appendix 4, further includes: a metal plate fastened to distal ends of the plurality of bosses; and a resin plate interposed between a surface of the metal plate and the motor connection AC connector, in which the motor connection AC connector is fixed to the boss through the resin plate and the metal plate.

### Appendix 6

The power conversion device according to Appendix 4 or 5 is in which the support plate includes the plurality of bosses having different shapes as viewed in the protruding direction.

### Appendix 7

The power conversion device according to any one of Appendixes 1 to 6 is in which the motor connection AC connector is a six-phase connector to which a first motor and a second motor different from the first motor, which are included in the motor, are connected, and includes insertion slots linearly arranged.

What is claimed is:

1. A power conversion device comprising:
a power module forming at least a part of a power conversion circuit;
a motor connection AC connector configured to be connected to a motor-side connector included in a motor;
a motor connection bus bar connecting the motor connection AC connector and the power module;
a cover portion configured to come into contact with the motor-side connector and covering the power module; and
a connector-fixing portion formed into a separate body from the cover portion and to which the motor connection AC connector is fixed.

2. The power conversion device according to claim 1, further comprising:
a support plate supporting the power module,
wherein the support plate is the connector-fixing portion.

3. The power conversion device according to claim 2,
wherein the power module is supported to face a connector-facing surface that is a surface of the support plate on the motor connection AC connector-side.

4. The power conversion device according to claim 3,
wherein the support plate includes a plurality of bosses formed to protrude from the connector-facing surface and to which the motor connection AC connector is fixed, and
the power module is positioned between the connector-facing surface and a distal end of a boss of the plurality of bosses in a protruding direction of the boss.

5. The power conversion device according to claim 4, further comprising:
a metal plate fastened to distal ends of the plurality of bosses; and
a resin plate interposed between a surface of the metal plate and the motor connection AC connector,
wherein the motor connection AC connector is fixed to the boss through the resin plate and the metal plate.

6. The power conversion device according to claim 4,
wherein the support plate includes the plurality of bosses having different shapes as viewed in the protruding direction.

7. The power conversion device according to claim 1,
wherein the motor connection AC connector is a six-phase connector to which a first motor and a second motor different from the first motor, which are included in the motor, are connected, and includes insertion slots linearly arranged.
